(19) United States
(12) Patent Application Publication
(10) Pub. No.: US 2007/0051356 A1
(43) Pub. Date: Mar. 8, 2007

(54) System for cutting stone

(76) Inventor: Lawrence L. Getty, Salem, CT (US)

Correspondence Address: BACHMAN & LAPOINTE, P.C., 900 CHAPEL STREET, SUITE 1201, NEW HAVEN, CT, 06510, US

(21) Appl. No.: 11/509,369

(22) Filed: Aug. 24, 2006

Related U.S. Application Data
(60) Provisional application No. 60/711,153, filed on Aug. 24, 2005.

(51) Int. Cl. B28D 1/04

(52) U.S. Cl. 125/13.01

(57) ABSTRACT

A system for cutting stone includes a rotary saw; and a stone support member movably positioned relative to the saw so that a stone workpiece positioned thereon can be cut in two passes, wherein the first pass cuts the stone substantially half way through a thickness of the stone, and the second pass cuts the stone through a remaining thickness of the stone.

### CROSS REFERENCE TO PROVISIONAL APPLICATION

This application claims the benefit of the filing date of provisional application Ser. No. 60/711,153 filed Aug. 24, 2005.

### BACKGROUND OF THE INVENTION

The invention relates to a system and method for cutting stone.

Various stone materials such as granite are used for many diverse building and landscaping applications. Such materials are frequently desired in thin, flat and smooth pieces. Unfortunately, making such thin flat pieces is a time consuming process, and requires much manpower as well.

It is clear that the need exists for an improved method for making such stone pieces.

It is therefore the primary object of the present invention to provide such a system and method.

### SUMMARY OF THE INVENTION

According to the invention, a system is provided which includes a rotary saw, and at least one workpiece support slidably mounted relative to the saw and rotatable around a vertical axis up to at least 180 degrees. This system allows a piece of stone to be firmly mounted on the workpiece support, and then cut with the saw using two passes. In the first pass, the stone is cut at least half way through the width of the starting material. The workpiece support is then returned to a starting position relative to the saw and prepared for a second pass to finish the cut. For the second pass, the workpiece support is rotated, preferably 180 degrees, to bring the non-cut side of the stone to face the saw. Before making the pass, it is preferred to place a shim or similar structure at roughly the mid-point of the stone, in the cut. By applying a weight or other force to the cut side of the stone, the shim will act as a lever and the weight will pivot the upper portion of the stone relative to the lower portion of the stone and thereby prevent the cut stone from pinching the saw blade.

With shim and weight in place, the stone is then moved through a second pass relative to the saw blade and the cut is finished.

According to the invention, more than one workpiece support can be positioned relative to the saw and, with this configuration, more than one workpiece can be cut at the same time, thereby increasing efficiency. Further, stone is cut in this method with a smaller blade, thereby conserving space and blade cost, and allowing a greater quantity of product to be made with a smaller blade.

In one embodiment, the saw blade itself is laterally stationary, and is rotated while the workpiece supports are moved, for example in guide tracks. In another embodiment, the workpiece support can be kept laterally stationary, and the blade moved past same. In this latter embodiment, while the workpiece support is preferably still rotatable at least 180 degrees to allow positioning for the second pass by positioning of the support, it is possible to relatively position the saw relative to the support by laterally moving the blade to the other side of the support.

In order to provide a consistent press of the workpiece against the saw, hydraulic or pneumatic cylinders, or electric motors, can be positioned to move the workpiece support relative to the saw.

### BRIEF DESCRIPTION OF THE DRAWINGS

A detailed description of preferred embodiments of the present invention follows, with reference to the attached drawings, wherein:

FIG. 1 schematically illustrates a system according to the invention;

FIG. 2 illustrates a support lift mechanism according to the invention;

FIG. 3 is a side schematic view of a system according to the invention;

FIG. 4 is a side schematic view of a table and workpiece support according to the invention;

FIG. 5 is illustrates one embodiment of a workpiece support according to the invention;

FIGS. 6 and 7 illustrate alternative structures allowing the support table to rotate according to the invention; and

FIG. 8 illustrates a workpiece in several stages of cutting.

### DETAILED DESCRIPTION

The invention relates to a stone cutting system and method which allows for cutting of rough stone workpiece material into relatively thin, flat pieces in an efficient and reliable manner. According to the invention, a relatively small rotating saw blade can be used to cut a large quantity of stone, obtaining large output as compared to the size of the blade, and reducing the size of the system and manpower needed to operate same.

FIG. 1 shows a system 10 according to the invention which includes a saw 12, a table 14, and two workpiece supports 16, 18. Supports 16, 18 are used to support a rough piece of stone which is to be cut to provide relatively thin, flat pieces of stone.

Saw 12 can be any readily available rotary saw, preferably having a blade suitable for cutting stone, for example having a diamond cutting edge. Of course, other suitable blades could be used as well. Saw 12 is preferably supported relative to table 14, for example on a support 20, and is rotatable to cut stone as will be further discussed below.

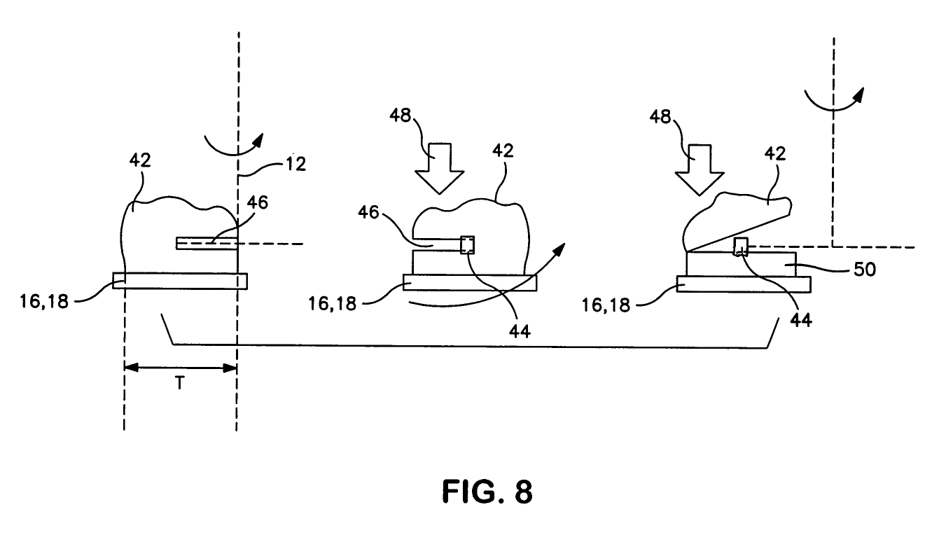

Supports 16, 18 are positioned in this embodiment to allow two pieces of stone to be cut at the same time. Supports 16, 18 are slidably mounted within table 14 so that they can be moved relative to saw 12 in cutting passes where a stone mounted on support 16, 18 is cut by saw 12, preferably to a depth into the rough stone which is slightly more than half way through same. This is further illustrated in FIG. 8 discussed below.

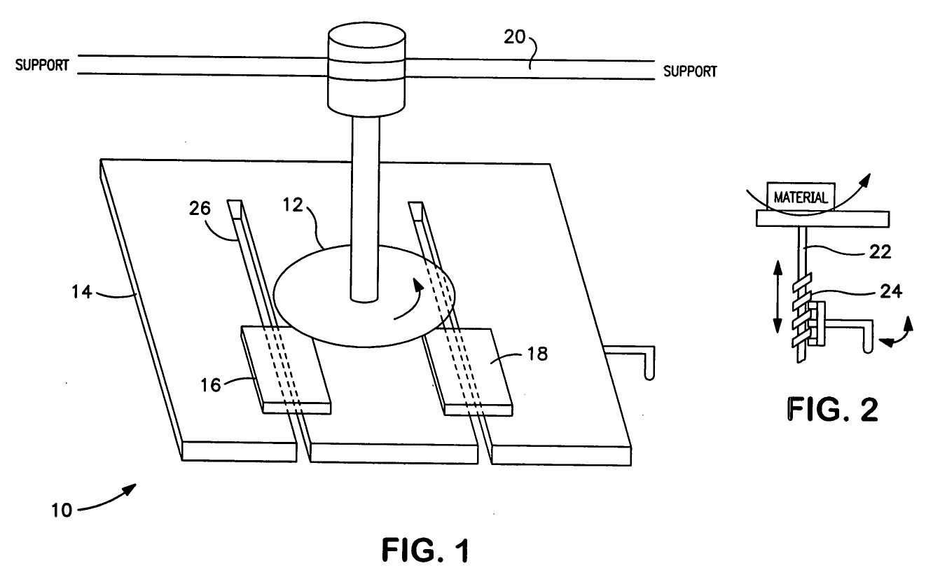

Supports 16, 18 are preferably mounted relative to table 14 and/or saw 12 so that they can be rotated at least about 180 degrees around a substantially vertical axis as schematically illustrated in FIG. 2. This allows a stone to be completely cut in 2 passes. In the first pass, the stone is cut, preferably slightly past the mid point. The support is then rotated to bring the non-cut portion into alignment with the saw, and a second pass finishes the cut. This is also further illustrated in FIG. 8 discussed below.

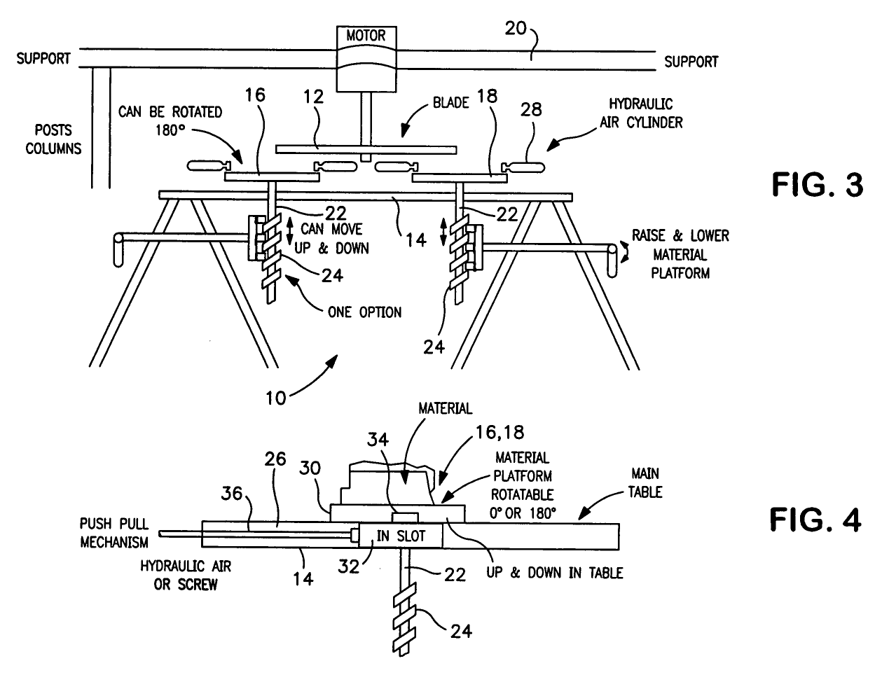

FIG. 3 further illustrates system 10 according to the invention. As shown in FIGS. 2 and 3, it is preferred that supports 16, 18 be vertically adjustable so that the thickness of the final cut stone can be selected. FIGS. 2 and 3 show supports 16, 18 mounted on a shaft 22 having a helical structure 24 which engages with a driver so that rotation of the driver raises or lowers support 16, 18. While this is one mechanism for mounting support 16, 18 to allow vertical positioning, it should be readily apparent that there are numerous other alternatives for vertically positioned supports 16, 18 all of which fall well within the broad scope of the present invention.

In order to increase versatility of system 10, it may be desired to mount saw 12 in such a way that it is vertically and/or laterally adjustable relative to supports 16, 18.

In the embodiment illustrated in the drawings, supports 16, 18 move laterally relative to saw 12 in slots 26 in table 14. Sliding of supports 16, 18 in slots 26 advantageously provides uniform and controlled motion of supports 16, 18 and the workpiece carried on same, relative to saw 12. This results in a reproducible, good quality cut. Supports 16, 18 can be moved along slots 26 using hydraulic, pneumatic and/or electric mechanisms, or in any other manner known to a person of ordinary skill in the art, preferably suitable for applying a consistent pressure on the slide mechanism. In the illustration of FIG. 3, supports 16, 18 move normal to the plane of the illustration, that is, into and out of the plane of the drawing. FIG. 3 shows a series of hydraulic cylinders 28 which can be used to firmly clamp a stone piece to support 16, 18. Of course, other mechanisms could be used to secure the stone workpiece relative to supports 16, 18, all well within the broad scope of the present invention.

Turning to FIG. 4, a preferred embodiment of support 16, 18 with moving mechanisms is illustrated. As shown, support 16, 18 can have a support platform 30 rotatably mounted to a slide member 32 which is slidably positioned in slot 26. Rotation of platform 30 relative to the vertical axis (for example defined by shaft 22) can be manually accomplished using an adjustable fixture shown schematically at 34. Vertical positioning of support platform 30 is accomplished through vertical adjustment of the position of shaft 22 as discussed above. Finally, sliding motion of support 16, 18 relative to slot 26 is accomplished using a push/pull mechanism 36 illustrated in the drawing as a hydraulic or pneumatic cylinder, or alternatively using a screw or electrically driven mechanism.

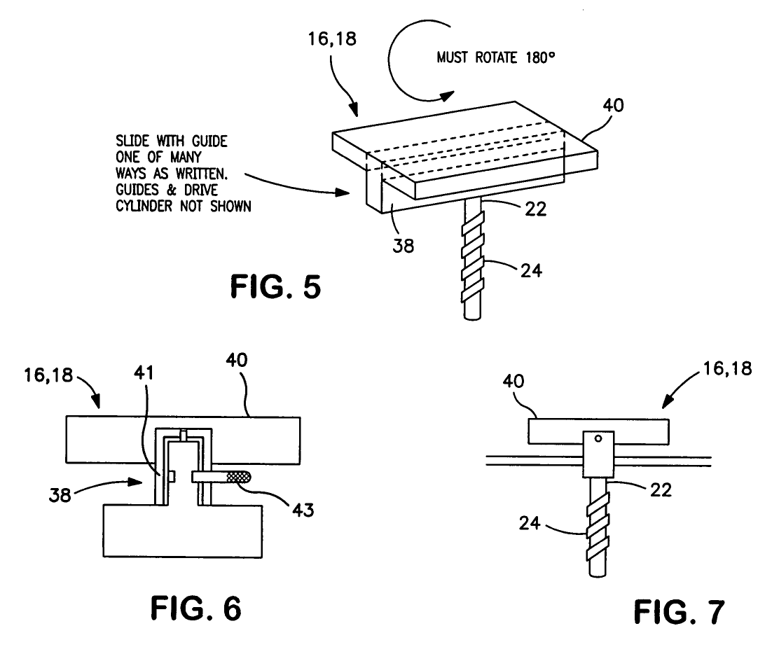

FIG. 5 shows a further illustration of a support 16, 18 according to the invention. As shown, support 16, 18 could be provided as a sliding base 38 and a support platform 40, wherein platform 40 can be mounted to sliding base 38 in two different directions. Thus, in this embodiment, after the first pass, platform 40 can be removed from sliding base 38 and re-attached in a 180 degree rotated position. FIGS. 6 and 7 illustrate methods whereby such rotatable connection can be accomplished. FIG. 6 shows platform 40 having a sleeve 42 and set screw 44 which are used to engage a lower structure which could alternatively be sliding base 38 or some other intermediate structure supporting platform 40. FIG. 7 shows a similar embodiment, wherein platform 40 is mounted relative to shaft 22 also using a set screw-type structure.

The slide mechanism for sliding relative to slots 26 can advantageously utilize lined bearings on chrome rods, tracks with V groove wheels, Teflon™ slides boxed in over box tubing and the like. Of course, other suitable slide structures would be apparent to a person of skill in the art as well, and such other mechanisms are well within the broad scope of the present invention.

FIG. 8 shows a series of steps illustrating operation of the system of the present invention, as well as the cutting method of the present invention. In the left-most illustration of FIG. 8, a stone workpiece 42 is shown mounted on a support 16, 18 after completion of a first cutting pass. Saw 12 is shown schematically in dashed lines. As shown, workpiece 42 has been cut substantially half way through a thickness T thereof.

After completion of the first pass, support 16, 18 and workpiece 42 positioned thereon are rotated 180 degrees to the position shown in the center illustration of FIG. 8, so that the non-cut portion of workpiece 42 is aligned with saw 12. Shims 44 are then preferably positioned within the cut 46 from the first pass, preferably as close as possible to the center point of the workpiece as shown. A weight or other manner of providing a force is then applied to exert a downward force on the upper portion of workpiece 42 at the already cut portion. This is done to generate a rotating force on the upper portion of workpiece 42 which will tend to open the upper and lower portions of the workpiece at the vicinity of saw 12 during the second cutting pass. Force 48 can be applied using weights, for example, or in any other manner known to a person of skill in the art.

During the second cut, illustrated in the right illustration of FIG. 8, saw 12 completes the cut resulting in a final cut product 50. As shown, the positioning of shims 44 and force 48 result in the upper portion of workpiece 42 pivoting relative to final cut product 50 in a direction which is away from blade 12 so that blade 12 is not pinched as the cut is completed. Of course, it must be appreciated that many other means of applying the desired force to workpiece 42 to avoid pinching of blade 12 are well within the broad scope of the present invention.

Returning to the illustration of FIG. 1, as set forth above, this embodiment utilizes two different supports 16, 18. Such a configuration advantageously allows for two different stone pieces to be cut at the same time and thereby increases output. Further, cutting opposed stone pieces as shown (i.e. stone pieces on opposite sides of the blade) tends to balance the forces exerted on saw 12 during cutting and thereby provides for a more stable system. This in turn results in greater saw blade life, fewer system repairs and the like. Of course, the broad scope of the present invention extends to systems utilizing only one support, and equally to systems utilizing more than two supports.

It should be appreciated that the system and method of the present invention will allow for greatly increased production as compared to systems cutting stone pieces in a single pass, and further that this is accomplished using a much smaller blade.

It should also be appreciated that, as mentioned above, the saw itself can move back and forth while the supports 16, 18 are held stationary, and this configuration is also within the broad scope of the present invention.

The use of a smaller diameter saw blade, and cutting deeper with the blade by going half way at a time, all result in reduced diamond wear and, thereby, greater blade life. The controlled pressure of the stone against the blade also helps to reduce wear on the blade, and with the present invention, plunge cut speed is set.

It should be appreciated that the system of the present invention is particularly well suited to bulk sawing projects and, particularly, to cutting of natural thin stone or any other building stone products. In further accordance with the invention, a plurality of saws can also be configured in side by side or in a series arrangement to further enhance production which is possible using the system of the present invention.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

What is claimed is:

1. A system for cutting stone, comprising:
a rotary saw; and
a stone support member movably positioned relative to the saw so that a stone workpiece positioned thereon can be cut with the saw during a cutting pass of the support member relative to the saw, the stone support also being positionable relative to the saw between a first position wherein a first portion of the support member is overlapped by the saw during a first cutting pass, and a second position wherein a second portion of the support member is overlapped by the saw during a second cutting pass.

2. The system of claim 1, wherein the first portion and the second portion together cover the support member, whereby the first cutting pass cuts a stone workpiece on the support member partially through a width of the stone workpiece, and the second cutting pass cuts the stone workpiece through a remaining width of the stone workpiece.

3. The system of claim 2, wherein the stone support member is vertically positionable relative to the saw whereby thickness of a cut product can be adjusted.

4. The system of claim 1, wherein the support member is rotatable around a substantially vertical axis between the first position and the second position.

5. The system of claim 1, wherein the stone support member comprises two stone support members positioned to opposite sides of the saw whereby two stone workpieces can be cut with each cutting pass of the saw relative to the support members.

6. The system of claim 1, wherein the support member comprises a base slidable in a slot of a work table, and a support surface member positionable relative to the base between the first position and the second position.

7. The system of claim 1, further comprising a table for slidably supporting the support member relative to the saw.

8. The system of claim 7, further comprising a guide slot in the table for guiding the support member during a cutting pass.

9. A method for cutting stone with a rotary saw, comprising the steps of:
providing a stone workpiece having a width;
cutting the workpiece in a first pass with a rotary saw to a point beyond half the width but less than the total width so as to provide a partially cut workpiece having a first pass cut and a non-cut portion;
aligning the partially cut workpiece so that the non-cut portion is aligned with the saw;
cutting the workpiece in a second pass with the rotary saw to complete the cut through the width of the workpiece.

10. The method of claim 9, further comprising the step of positioning a shim in the first pass cut and applying a downward force to an upper portion of the workpiece defined by the first pass cut, whereby the force and shim cause the upper portion of the workpiece at the non-cut portion to rotate away from the saw during the second pass.
